(19) United States
(12) Patent Application Publication
(10) Pub. No.: US 2007/0267448 A1
(43) Pub. Date: Nov. 22, 2007

(54) Foam Head, and Foam Head with a Propellant Container

(76) Inventors: Maria Gross, Pfungstadt (DE); Harald Lohnes, Brombachtal (DE); Gabriele Stolper, Rossdorf (DE)

Correspondence Address: MICHAEL J. STRIKER, 103 EAST NECK ROAD, HUNTINGTON, NY, 11743, US

(21) Appl. No.: 10/581,010

(22) PCT Filed: Dec. 6, 2004
(86) PCT No.: PCT/EP04/13851

§ 371 Date: Feb. 16, 2007

(30) Foreign Application Priority Data
Dec. 6, 2003 (DE) 103 57 179.5

(51) Int. Cl. B65D 83/00; B05B 7/28

(52) U.S. Cl. 222/402.13

(57) ABSTRACT

Disclosed is a foam head (1) for a propellant container (2) with an inner and an outer crimped edge (3, 4) of a valve disk (5). Said foam head (1) comprises an actuating button (6) and a foam discharge port (7) and is embodied so as to sit directly on a valve stem (8). A bottom section (9) of the foam head (1) has an outer diameter (10) that is approximately identical to an inner diameter (11) of the inner crimped edge (3). An outer rib (13) which faces the actuating button (6) is disposed in a lower area (12) of the bottom section (9) so as to engage underneath a bottom side (14) of the inner crimped edge (3). A lower edge (15) of the bottom section (9) is provided with at least one recess (16) in order to form an annular spring (17).

The invention relates to a foam head as generically defined by the preamble to claim 1 and to a foam head having a propellant container as generically defined by the preamble to claim 2.

A foam head of this generic type made of plastic as a mass-produced article is known for instance from European Patent Disclosure EP 0792821 A1, which for securing purposes is connected to an outer crimped edge of a propellant container.

By comparison, the first object of the invention is to create a foam head which by simple provisions attains substantial savings in material consumption. The second, coordinate object of the invention is to create a foam head having a propellant container, which by simple provisions achieves a substantial savings in material consumption, and in which by simple provisions, the propellant container can be used for further purposes.

These objects are attained in accordance with the characteristics of the bodies of claims 1 and 2, respectively. Further advantageous embodiments and features of the invention will become apparent from the dependent claims.

The invention will now be described in further detail in terms of two exemplary embodiments.

Shown are:

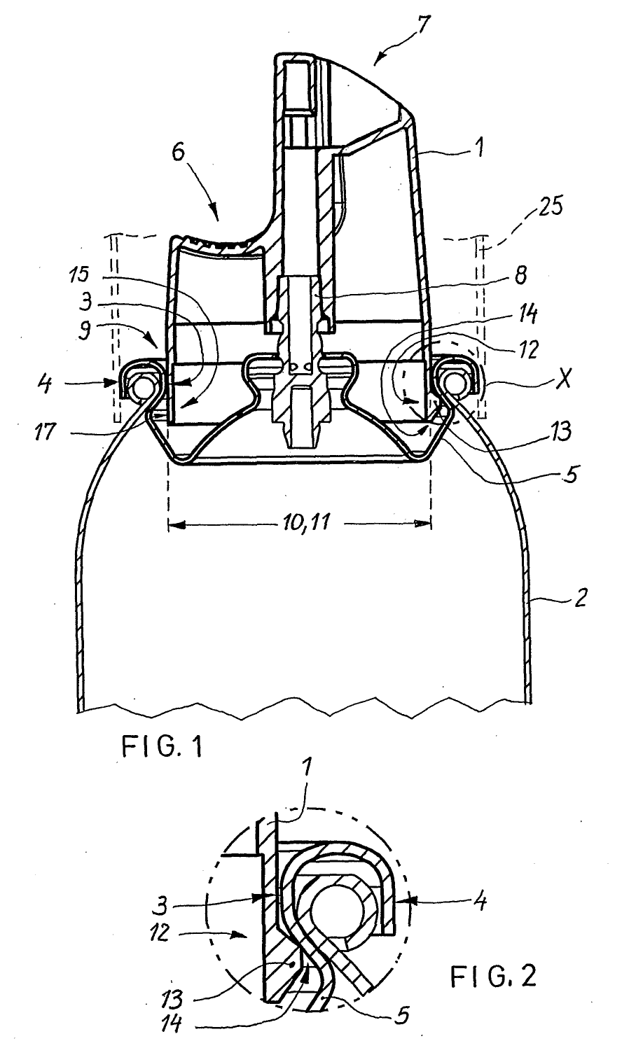

FIG. 1, in an axial sectional view, a first exemplary embodiment of an unactuated foam head, which is connected to a propellant container;

FIG. 2, a detail X in FIG. 1;

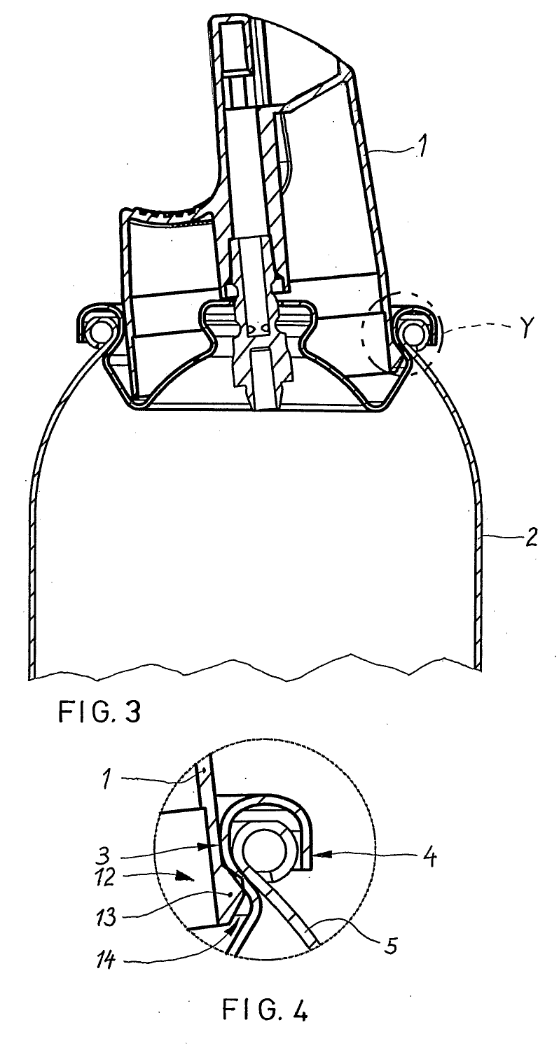

FIG. 3, an axial sectional view as in FIG. 1, but in an actuated state;

FIG. 4, a detail Y in FIG. 3;

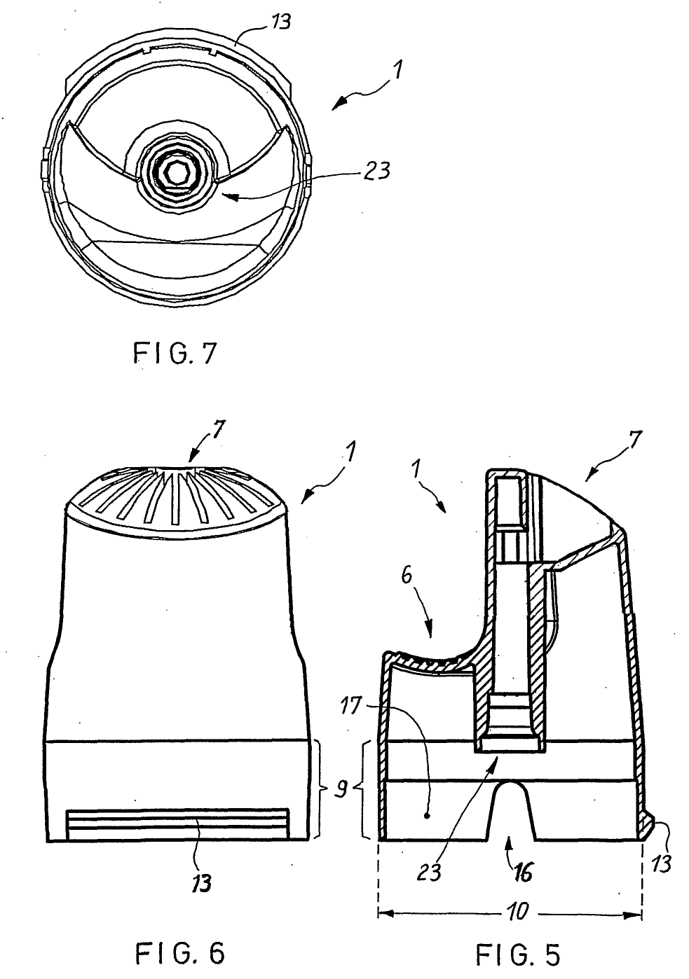

FIG. 5, a foam head of FIG. 1, by itself;

FIG. 6, the foam head of FIG. 5 in a side view;

FIG. 7, the foam head of FIG. 6 in a view from below;

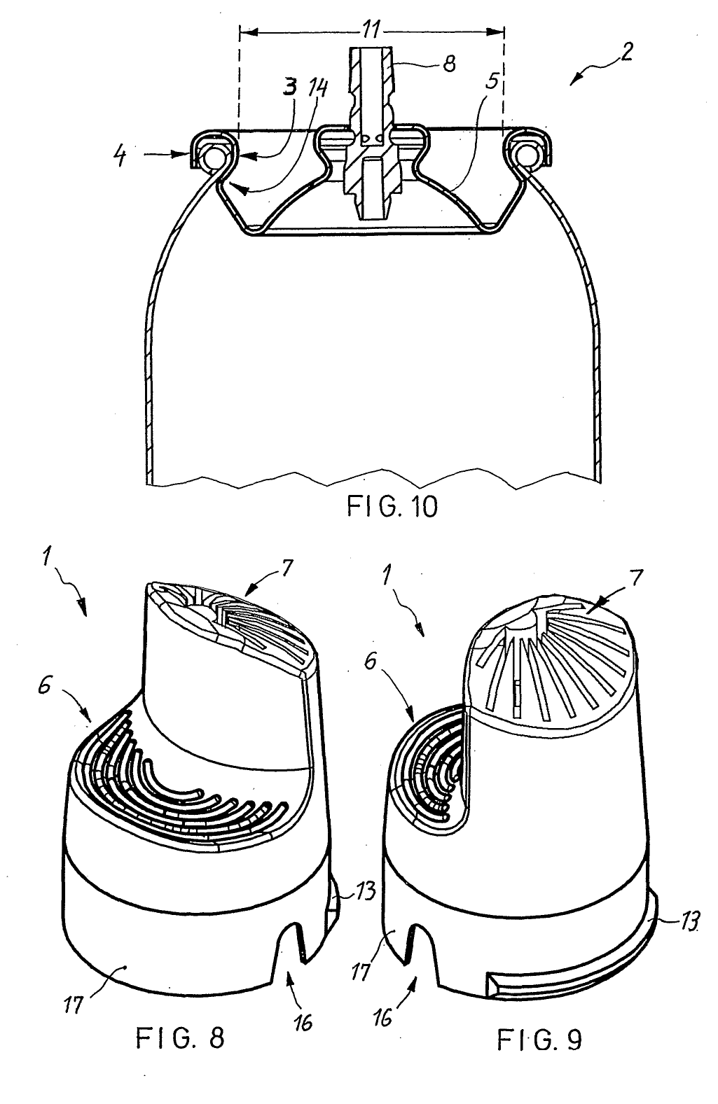

FIGS. 8 and 9, in different perspective views, the foam head of FIG. 6;

FIG. 10, in an axial sectional view, a propellant container without a foam head;

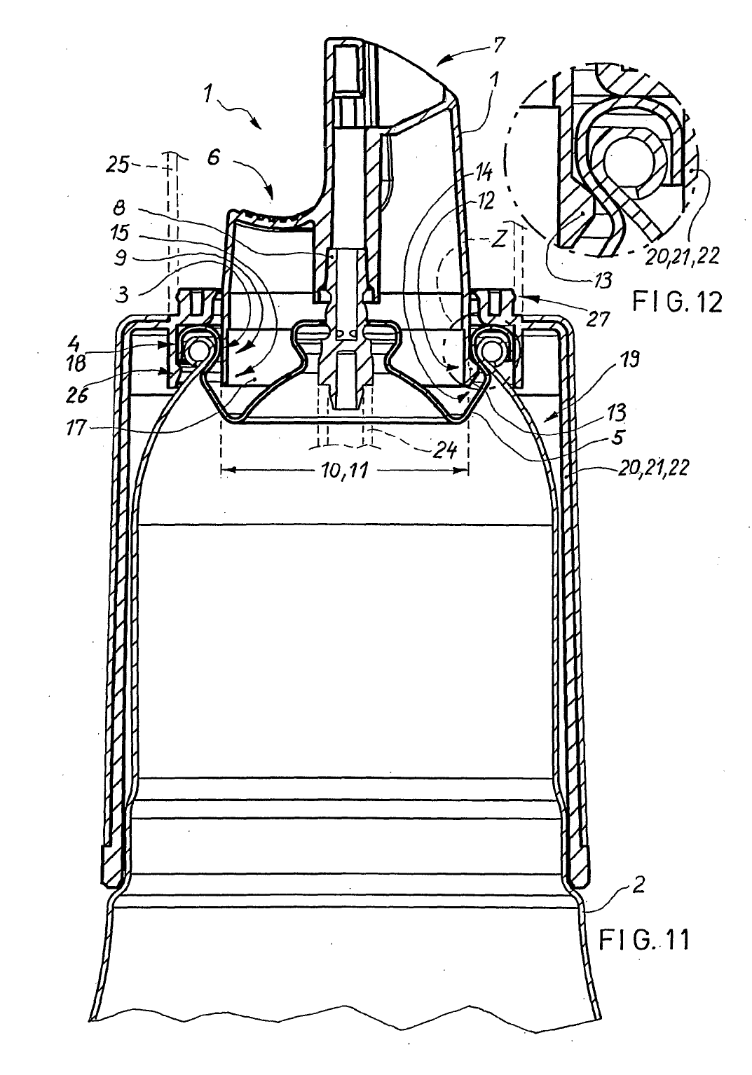

FIG. 11, in an axial sectional view, a second exemplary embodiment of an unactuated foam head, which is connected to a propellant container and which is connected to a sleeve at the outer crimped edge; and

FIG. 12, a detail Z in FIG. 11.

FIG. 1 shows, as the first exemplary embodiment, a foam head 1 for a propellant container 2, having one inner and one outer crimped edge 3, 4 of a valve plate 5, in which the foam head 1 having an actuation button 6 and a foam dispensing opening 7 is embodied as seatable directly on a valve stem 8. A lower portion 9 of the foam head 1 has approximately the same outer diameter 10 as an inner diameter 11 of the inner crimped edge 3, and the lower portion 9 of the foam head 1 can also be tilted as shown in FIG. 3 inside the inner crimped edge 3. In a lower region 12 of the lower portion 9, diametrically opposite the actuation button 6, there is an outer rib 13 for engaging a lower side 14 of the inner crimped edge 3 from below. For the sake of forming an annular spring 17, a lower edge 15 of the lower portion 9 is provided with at least one recess 16. It is thus assured that the foam head 1 can be actuated and remains joined to the propellant container 2 and cannot fall off. The restoring force after the actuation of the actuation button 6 for applying a partial amount of foam is provided by the spring-elastic valve stem 8.

The foam head 1, to prevent unintentional actuation, can be provided with a guard cap 25, shown in dashed lines, which is joined to the outer crimped edge 4 in such a way that it can be detached again.

FIG. 2 shows a detail X in FIG. 1.

FIG. 3 shows an axial sectional view as in FIG. 1, but in a state in which it is actuated with the actuation button 6. From this, tilting of the outer rib 13 on the lower side 14 of the inner crimped edge 3 is clearly visible.

FIG. 4 shows a detail Y in FIG. 3.

FIG. 5 shows a foam head of FIG. 1 by itself; it has a receptacle 23 for the valve stem 8.

FIG. 6 shows the foam head 1 of FIG. 5 in a side view.

FIG. 7 shows the foam head 1 of FIG. 6 in a view from below.

FIGS. 8 and 9, for further illustration, show the foam head 1 of FIG. 6 in different perspective views.

FIG. 10 shows in an axial sectional view, a propellant container 2 without a foam head 1.

FIG. 11 shows, as the second exemplary embodiment, a foam head 1 having a propellant container 2, having one inner and one outer crimped edge 3, 4 of a valve plate 5, in which the foam head 1 having an actuation button 6 and a foam dispensing opening 7 is embodied as seatable directly on a valve stem 8; a lower portion 9 of the foam head 1 has approximately the same outer diameter 10 as an inner diameter 11 of the inner crimped edge 3. In a lower region 12 of the lower portion 9, diametrically opposite the actuation button 6, there is an outer rib 13 for engaging a lower side 14 of the inner crimped edge 3 from below. For the sake of forming an annular spring 17, a lower edge 15 of the lower portion 9 is provided with at least one recess 16. It is thus assured that the foam head 1 can be actuated and remains joined to the propellant container 2 and cannot fall off. The restoring force after the actuation of the actuation button 6 for applying a partial amount of foam is provided by the spring-elastic valve stem 8. This second exemplary embodiment differs from the first exemplary embodiment of FIG. 1 essentially in that the outer crimped edge 4 is intended as a connecting seat 18 of a sleeve 20 sheathing at least the upper region 19 of the propellant container 2, and the sleeve 20 is joined to the outer crimped edge 4 by a snap ring 26. The sleeve 20 is embodied as a graspable part, making manipulation easier during application, especially if the graspable part 21 is embodied as slip-proof. The sleeve 20 can selectively be designed as a decorative part 22, for instance by means of a special coloring and/or imprint, for instance for providing additional information on the foam product. A haircare product, for instance, can be intended as the foam product.

The foam head 1, to prevent unintentional actuation, can be provided with a guard cap 25 (FIG. 11) shown in dashed lines, which is joined detachably to a clamping bead 27 above the sleeve 20, and the outer diameter of the clamping bead 27 is equivalent to the outer diameter of the crimped edge 4, making it possible to use commercially available guard caps 25.

FIG. 12 shows a detail Z in FIG. 11.

A secure tilting seat of the foam head 1 is assured by a collaboration of the annular spring 17, because of the spring action of the outer diameter 10 and the recess 16, with the outer rib 13 on one side, which catches below the inner, lower crimped edge 14. Manual pressure by a finger on the actuation button 6 of the foam head 1 causes the foam head 1 to tilt and the valve stem 8 to be activated. Two-finger actuation (by means of two diametrically opposed actuation faces) is also possible, given a suitably modified construction, but in that case the annular spring 17 has only a retention function and does not reinforce the tilting action.

The foam dispensing opening 7 on the foam head 1 is provided here for upside-down application (with the foam head 1 at the bottom), but it is also possible—as with the first exemplary embodiment of FIG. 1 also—for a horizontal application or one with the foam head 1 pointing upward to be provided; in that case, a corresponding (elastic) riser pipe 24 (shown in dashed lines) is joined to the lower part of the valve stem 8 and extends as far as the bottom (not seen) of the propellant container 2.

The foam head 1, to prevent unintentional actuation, can be provided with a guard cap 25 (FIG. 1) shown in dashed lines, which is joined to the outer crimped edge 4 in such a way that it can be detached again.

Mounting the foam head 1 on the valve stem 8 is done using high-speed systems (sliding seat on the valve stem 8 and face-end sealing upon actuation).

Because of the invention, a savings of material and cost reduction of approximately 50% is possible, compared with positional securing via the outer diameter 10 of the valve as in the prior art.

### LIST OF REFERENCE NUMERALS

1 Foam head
2 Propellant container
3 Inner crimped edge
4 Outer crimped edge
5 Valve plate
6 Actuation button
7 Foam dispensing opening
8 Valve stem
9 Lower portion of the foam head 1
10 Outer diameter
11 Inner diameter
12 Lower region of the lower portion 9
13 Outer rib
14 Lower side of the inner crimped edge 3
15 Lower peripheral region of the lower portion 9
16 Recess
17 Annular spring
18 Connecting seat
19 Upper region of the propellant container 2
20 Sleeve
21 Graspable part
22 Decorative part
23 Receptacle
24 Riser pipe
25 Guard cap
26 Snap ring
27 Clamping bead

1. A foam head (1) for a propellant container (2), having an inner and outer crimped edge (3, 4) of a valve plate (5), in which the foam head (1), having an actuation button (6) and a foam dispensing opening (7), is embodied as seatable directly on a valve stem (8), characterized in that a lower portion (9) of the foam head (1) has an outer diameter (10) approximately equal to an inner diameter (11) of the inner crimped edge (3); that in a lower region (12) of the lower portion (9), diametrically opposite the actuation button (6), there is an outer rib (13) for engagement from beneath of a lower side (14) of the inner crimped edge (3); and that a lower peripheral region (15) of the lower portion (9) is provided with at least one recess (16) for the sake of forming an annular spring (17).

2. A foam head (1) having a propellant container (2), having an inner and outer crimped edge (3, 4) of a valve plate (5), in which the foam head (1), having an actuation button (6) and a foam dispensing opening (7), is embodied as seatable directly on a valve stem (8), characterized in that a lower portion (9) of the foam head (1) has an outer diameter (10) approximately equal to an inner diameter (11) of the inner crimped edge (3); that in a lower region (12) of the lower portion (9), diametrically opposite the actuation button (6), there is an outer rib (13) for engagement from beneath of a lower side (14) of the inner crimped edge (3); that a lower peripheral region (15) of the lower portion (9) is provided with at least one recess (16) for the sake of forming an annular spring (17); and that the outer crimped edge (4) is intended as a connecting seat (18) of a sleeve (20) sheathing at least the upper region (19) of the propellant container (2).

3. The foam head (1) having a propellant container (2) as defined by claim 2, characterized in that the sleeve (20) is embodied as a graspable part (21).

4. The foam head (1) having a propellant container (2) as defined by claim 3, characterized in that the graspable part (21) is embodied as slip-proof.

5. The foam head (1) having a propellant container (2) as defined by claim 2, characterized in that the sleeve (20) is designed as a decorative part (22).

6. The foam head (1) having a propellant container (2) as defined by claim 2, characterized in that an upper part of the sleeve (20) is provided with a clamping bead (27) for mounting a guard cap (25) in such a way that it can be released again, and the outer diameter of the clamping bead (27) is equivalent to the outer diameter of the crimped edge (4).
